(19) United States
(12) Patent Application Publication
(10) Pub. No.: US 2012/0148906 A1
(43) Pub. Date: Jun. 14, 2012

(54) CHEMICAL CURRENT SOURCE

(75) Inventor: Aleksander Arkadievich POTANIN, Sarov (RU)

(73) Assignee: HIGH POWER BATTERY SYSTEMS LTD. (HPBS), Diveevskiy raion (RU)

(21) Appl. No.: 13/369,612

(22) Filed: Feb. 9, 2012

Related U.S. Application Data
(63) Continuation of application No. PCT/RU2010/000433, filed on Aug. 6, 2010.

(30) Foreign Application Priority Data
Aug. 10, 2009 (RU) 2009130492

(51) Int. Cl. H01M 2/02

(52) U.S. Cl. 429/163

(57) ABSTRACT

The chemical current source can be used in the electrical devices, wherein it is feeding the electrical devices that constantly operate or can temporarily/accidentally be under extreme conditions produced with the different negative factors such as fire, various types of radiation, including heat, electromagnetic etc., various types of mechanical effects, e.g. a blow and so on. The chemical current source consists of a housing with current feedthroughs and solid-state galvanic cells that are arranged within the housing and connected to the current feedthroughs, contain an anode, an electrolyte, a cathode based on solid-state ionic conductors. For the multifunctional use in the electrical device the chemical current source is made as a thermal protection and (or) a protective shield for the protection of the electrical device or some its parts against external effects and (or) environment against effects going from the electrical device or some its parts.

### RELATED APPLICATIONS

This Application is a Continuation application of International Application PCT/RU2010/000433 filed on Aug. 6, 2010, which in turn claims priority to Russian application No. RU2009130492 filed on Aug. 10, 2009, both of which are incorporated herein by reference in their entirety.

### FIELD OF THE INVENTION

The present invention relates to electrical engineering area, in particular to chemical current sources (chemical batteries).

The invention can be of interest in various arts, where chemical current sources are used for feeding of electrical devices that constantly operate or can temporarily/accidentally be under extreme conditions. At that, influence of different negative factors such as fire, various types of radiation, including heat, electromagnetic etc., various types of mechanical effects, e.g. a blow and so on is understood under the extreme conditions.

The invention can be of interest in the protection of the electrical devices against external detrimental effects, as well as in the protection of environment against detrimental effects going from the electrical devices.

According to the invention, the electrical device is appliances, machinery, mechanisms, instruments and other equipment, wherein chemical current sources (batteries) are used.

According to the present invention the chemical current source is both a separate galvanic cell consisting of a negative current collector, an anode, an electrolyte, a cathode and a positive current collector, connected in the mentioned order and a battery, consisting of several galvanic cells, connected both in parallel and/or in series. At that, the galvanic cells are arranged inside the battery's body with two isolated current feedthroughs (terminals) and, are connected to the feedthroughs in compliance with polarity. At that, the battery's housing can also serve as one of the feedthroughs, and the chemical current source can be both the primary one and the secondary one.

### BACKGROUND OF THE INVENTION

Various types of protective units for protection of the electrical devices against fire, radiation and other detrimental effects are known. They are the different thermal protections and shields (analog) (Great encyclopedia//Moscow, “Terra”, 2006, v. 50, p. 328 and v. 60, p. 168). The mentioned protective units are a barrier that partially or totally absorbs energy of these effects and decreases influence of the effects on interior parts of the devices. Absorption of energy leads to the heating of the protective units, so they are made of heat-resistant materials. Shape of the protective units is determined by their capabilities to withstand the above-mentioned effects.

It is known that solid-state current sources based on solid-state ionic conductors have high performances along with high thermal stability and safety (U.S. Pat. No. 6,379,841 B1, HO1M4/58, issued on Apr. 30, 2002). These current sources contain the solid-state ionic conductors with high fluoride ion (F−) mobility in solid phase. Only solid-phase processes take place in these current sources, namely: the solid-phase current-producing reactions at the anode and cathode and the transfer of fluoride ions through the solid electrolyte. At that, the current sources consist of heat-resistant complex fluorides, which ensure their safety and thermal stability, as well as operability up to 550 C. Furthermore, discharge power of the current sources increases substantially at temperature rise, namely: (1-2)10-5 W at 25 C, (2-3)10-4 W at 100 C, (5-9) 10-3 W at 200 C, (2-4) 10-2 W at 300 C and (0.5-1) W at 500 C.

A solid-state chemical current source, which is the closest to the present invention (prototype), is that disclosed in the RF Patent No 2313158 HO1M 6/18, 10/36, issued on Dec. 20, 2007. The solid-state chemical current source contains a housing with current feedthroughs and solid-state galvanic cells that are arranged within the housing and are connected to the current feedthroughs, wherein the galvanic cells consist of an anode, an electrolyte, a cathode and a thermal protection, which decreases the heat loss of the heated galvanic cells. At that, the galvanic cells are on the base of solid-state ionic conductors and can serve simultaneously as heating elements.

This chemical current source has the following properties:

1. Safety, wide operating temperature range and low self-discharge.

2. High discharge power when the solid-state galvanic cells are in a heated state, while the thermal protection is used for decreasing heat loss of the heated galvanic cells.

The prototype has two main drawbacks, namely: it does not have multifunctional purpose and the thermal protection is designated only for the prototype's operation.

### SUMMARY OF THE INVENTION

The task of the present invention is to create an apparatus of the chemical current source for its multifunctional use in the electrical devices, where the chemical current source will not only feeds the electrical device, but it also will completely or partially protect the electrical device or some its parts against external detrimental effects and/or will completely or partially protect environment against detrimental effects, going from the electrical devices or some its parts.

The technical result of the present invention is the following:

Additionally to the feeding of the electrical device the chemical current source partially or totally protects
the electrical device or some its parts against the influence of fire and (or) heat radiation, and (or) other effects that can lead to impermissible heating of the electrical device or some its parts;
environment against fire and (or) heat radiation going from the electrical device or some its parts;
the electrical device or some its parts against external electromagnetic and other types of radiations, and (or) environment against influence of these radiations if the electrical device or some its parts are a source of these radiations;
the electrical device or some its parts against external mechanical effects and (or) completely or partially environment against detrimental effects going from the destruction products of the electrical device or some its parts.

In order to accomplish the aforementioned task and technical result the following apparatus of the chemical current source is proposed:

1. The chemical current source, comprising the housing; one or several galvanic cells which are arranged within the housing, are connected between each other, contain the anode, the electrolyte and the cathode that are based on the solid-state ionic conductors; the current feedthroughs that serve as terminals for the connection with the electrical device. According to the invention the chemical current source is made as a thermal protection and/or a protective shield for protection of the electrical device or some its parts against external influence of fire, and (or) radiation, and (or) mechanical effects, as well as for protection of environment against similar effects going from the electrical device or some its parts.

The chemical current source can be made in the form of a plate.

It can have an inner hollow or be made in the form of a hollow cylinder.

The chemical current source can serve as a case or a part of the case of the electrical device or some its parts.

The chemical current source is fire-safe and explosion-proof because of use of the solid-state galvanic cells based on the solid-state ionic conductors. The chemical current source is made from the heat-resistant materials, and all processes that are responsible for the discharge parameters take place in solid phases without any participation of gaseous and/or liquid components (A.A. Potanin. Solid State Chemical Battery with LaF3— Like Ionic Conductors.//Russ. Chem. Journ. (J. of Mend.Russ. Chem. Soc.), 2001, v. 45, No 5-6, pp. 58-63). The heat of this chemical current source leads to increase in ionic conductivity of the solid-state ionic conductors as well as in rate of electrode reactions at the solid-phase anode and cathode. As a result of this, the battery's internal resistance drops, and its discharge power increases, i.e. the battery fully maintains its operability during the heating. Moreover, the discharge and energy characteristics of this chemical current source increase also (RF Patent No 2313158 HO1M 6/18, 10/36, issued on Dec. 20, 2007; A.A. Potanin. Solid State Chemical Battery with LaF3— Like Ionic Conductors.//Russ. Chem. Journ. (J. of Mend.Russ. Chem. Soc.), 2001, v. 45, No 5-6, pp. 58-63).

The fact that the chemical current source is made as a thermal protection and/or a protective shield allows using it for multifunctional purposes in the electrical devices, namely: along with feeding of the electrical devices it partially or completely absorbs different energy of the external detrimental effects, thereby decreasing the influence of these effects on interior parts of the electrical devices, and at that it maintains its operability.

The high battery's thermal stability allows protecting the electrical device or some its parts against overheating caused by the external detrimental effects of different nature such as fire and (or) radiation, elevated ambient temperature, friction etc. The absorption of energy by the chemical current source made as a thermal protection and/or a protective shield leads to its heating and protection of the electrical device or some its parts against overheating, correspondingly. At that, the chemical current source keeps operability and its discharge parameters are growing during the heating. Shape of the chemical current source made as a thermal protection and/or a protective shield is determined by its capability to efficiently absorb energy of the detrimental effects and to protect the electrical device against these effects. In this chemical current source the most efficient materials for the housing, as well as a mass and a thickness of the housing, etc. can be chosen to increase the absorption of the detrimental effect energy.

If the electrical device or some its parts serve as a source of the detrimental effects for environment, the chemical current source made as a thermal protection and/or a protective shield absorbs energy of these detrimental effects, decreasing negative influence of the electrical device or some its parts on environment.

This chemical current source can be placed inside the electrical device. In this case it protects some parts of the electrical device against the detrimental effects going from the other parts of the electrical device.

The use of the solid-state chemical current source made as a thermal protection and/or a protective shield results in the important practical result—multifunctional application of the current source, namely: along with the feeding of the electrical devices the chemical current source protects the electrical devices or some their parts against the external detrimental effects and/or environment against the detrimental effects going from the electrical devices or some their parts.

It should be emphasized that only the chemical current source with the solid-state galvanic cells containing the anode, the electrolyte and the cathode, which are based on the solid-state ionic conductors can be simultaneously used as a power supply and a protective unit. The use of the other chemical current sources containing, for example, liquid or polymeric electrolytes, for the protection against detrimental effects will not solve the task of this invention, because such chemical current sources are destroyed under the heating, produced by the absorption of the detrimental effect energy, and they should be protected against heating or cooled for their normal operation.

The use of the solid-state galvanic cells based on the solid-state ionic conductors allows making the battery in the form of a multilayer metal-ceramic structure, consisting of one or several galvanic cells (RF Patent No 2313158 HO1M 6/18, 10/36, issued on Dec. 20, 2007). At that, each galvanic cell is also a sintered multilayer metal-ceramic structure consisting of thin layers of an anode, an electrolyte, a cathode and metal current collectors at the anode and cathode.

Such chemical current source consisting of the housing with current feedthroughs; one or several galvanic cells which are arranged in the housing and connected to the current feedthroughs, and comprise the anode, the electrolyte and the cathode which are based on the solid-state ionic conductors and connected with each other in parallel or in series, is a rigid and strength structure. The making of this battery structure as a protective unit or shield allows realizing a barrier from external mechanical effects and an additional functional use of the chemical current source as a complete or partial protection of the electrical device, for example against blows. At that, even when the destruction of the chemical current source is happened, it will keep its fire and explosion safety. Moreover, the chemical current source will not be a source of aggressive liquids and gases as it does not contain them.

2. The chemical current source is made in the form of a plate for its efficient use as a thermal protection and (or) a protective shield for the protection against the directional detrimental effects.

In this case the chemical current can absorb more energy of the directional detrimental effects because of its large surface. The chemical current source made as a thermal protection and (or) a protective shield can be installed on or near the case of the electrical device or some its parts. It can be also installed in available hollows of the electrical device for protection of some its parts.

In order to widen the surface of this thermal protection or protective shield several chemical current sources in the form of a plate can be placed near each other.

In order to increase the reliability of feeding each chemical current source can be connected with electrical device separately.

In order to increase the power of feeding the chemical current sources can be connected with each other in series or (and) in parallel, and then—with the electrical device. In this chemical current source the solid-state galvanic cells can be shaped like a plate and they are arranged in the housing forming a plane multilayer metal-ceramic structure. If it is functionally necessary to make the solid-state galvanic cells in the form of discs, the plate-shaped chemical current source can contain one or several such discs situated near each other, and free volume between the discs can be occupied by additional functional units, which made better the efficiency of the protection, for example heat storages, or parts that improve the mechanical strength of the plate.

3. In order to efficiently use the chemical current source as a thermal protection and (or) a protective shield for the protection against the detrimental effects going from the different directions this current source is made with an internal hollow, wherein the electrical device or some its parts are placed. In this case the chemical current source serves completely or partially as an outer case of the electrical device or some its parts and protects totally or partially the electrical device or some its parts against the external effects, and (or) environment against the detrimental effects going from the electrical device or some its parts.

Working as a protective unit, the chemical current source absorbs energy of the detrimental effects. At that the chemical current source will get warm keeping its function of a current source.

Making of the chemical current source with an internal hollow, wherein the electrical device is set, can be of practical interest for compact electrical devices, as well as for some small-size parts of these electrical devices, because influence of the external detrimental effects are the most harmful for them or these parts serve as a source of the detrimental effects on environment by themselves.

4. The chemical current source as a protective unit for the protection of compact electrical devices and some their parts against the detrimental effects can be made in the form of a hollow cylinder. In this case the solid-state galvanic cells that are the multilayer ring metal-ceramic structures can also have a ring form, and they can be arranged within the housing of the chemical current source.

5. In order to widen the multifunctional purpose of the chemical current source that is used as a protective unit and made as a thermal protection and (or) a protective shield for the protection of the electrical device or some its parts against the external effects, and (or) environment against the detrimental effects from the electrical device or some its parts, the chemical current source can be made in the form of a case/a part of the case of the electrical device or some its parts.

6. In order to protect the electrical device against fire the chemical current source made as a thermal protection and (or) a protective shield prevents completely or partially the direct influence of fire or heat radiation on the electrical device or some its parts. This chemical current source can also protect environment against fire and heat radiation if the electrical device or some its parts are a source of these detrimental effects. In this case the chemical current source has to have a heat-resistant housing e.g. metallic. The chemical current source can be made in the form of a plate for the protection against the directional effect of fire. If fire influences from different directions, the chemical current source can be made in the form of an outer case/a part of the case of the electrical device or some its parts. Heat radiation can be also absorbed by the chemical current source. When the chemical current source prevents influence of fire, it can be heated strongly. At that, the chemical current source goes on with its main function—it continues to feed the electrical device or some its parts. In the chemical current source the rise of temperature is accompanied with increase in discharge and energy parameters. This property can be used, for example, in the case of fire, namely: in order to prevent emergency conditions the chemical current source can feed powerful operating mechanisms of the electrical devices, such as fire-extinguishing means or robots. The efficiency of the chemical current source based on the solid-state ionic conductors as a protective unit for the protection against fire and heat radiation is determined by high heat capacity of the used materials and by low heat conductivity of the multilayer metal-ceramic structure of the galvanic cells. In order to improve the efficiency of the chemical current source made as a thermal protection for the protection against fire and heat radiation it can be additionally provided for the increase in its heat capacity for the additional accumulation of heat, for example, due to the housing mass enhancement.

As in the case of the heat radiation protection, the chemical current source can be made in the form of a shield and it can protect against other types of radiation. The chemical current source can screen electromagnetic radiation due to its metallic anode and cathode collectors. In order to improve the efficiency of the radiation protection special materials can be used for the housing of the chemical current source to absorb the energy of these radiations.

The heating of the housing and the chemical current source as a whole due to shielding of radiation will not lead to a decrease in operability of the current source in the electrical device or some its parts.

7. The chemical current source made as a thermal protection and (or) a protective shield can be efficiently used not only for the protection against effects, which lead to impermissible overheating of the electrical device or some its parts (e.g. fire or radiation), but also for the protection of the electrical device or some its parts against total or partial mechanical destruction due to the mechanical strength of the current source. At that, the chemical current source can protect the electrical device or some its parts against the external mechanical effects as well as environment against mechanical effects, caused by the destruction of the electrical device or some its parts. This property can be important for people safety.

The chemical current source made as a thermal protection and (or) a protective shield can be efficiently used not only for protection against some types of effects, such as fire, radiation, mechanical influence, but also for protection against a few of them or all at once.

### BRIEF DESCRIPTION OF THE DRAWINGS

FIG. 1 shows a sketch of the multifunctional chemical current source in the form of a plate for the protection of the electrical device or some its parts against the directional detrimental effects.

FIG. 2 shows a sketch of the multifunctional chemical current source in the form of a plate for the protection of the electrical device or some its parts against the detrimental effects going from different directions.

FIG. 3 shows a sketch of the multifunctional chemical current source that is made in the form of a hollow cylinder for the protection of the electrical device or some its parts, arranged within the cylindrical hole.

### DETAILED DESCRIPTION OF THE PREFERRED EMBODIMENTS

Operability of the claimed structure of the chemical current source consists in the following:

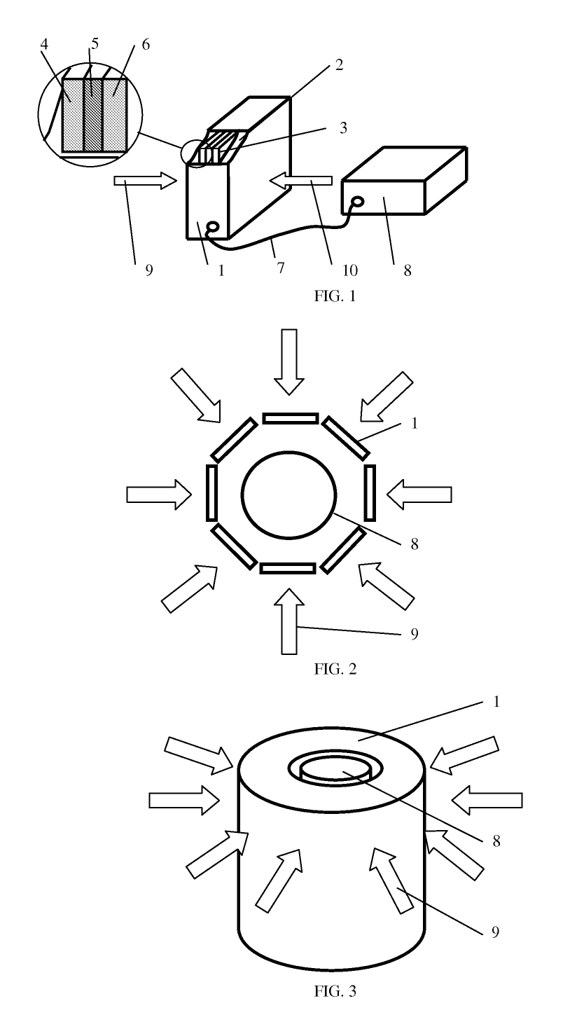

Referring to FIG. 1, the chemical current source 1 comprises the housing 2 and several solid-state galvanic cells 3 that are arranged in the housing, are connected to each other, comprise the anode 4, the electrolyte 5 and the cathode 6, which are based on the solid-state ionic conductors. The current feedthroughs 7 are provided for connection with the electrical device 8. The chemical current source feeds the electrical device 8 and it is made in the form of a plate that protects against external detrimental effects 9. Protecting against the detrimental effects, the chemical current source absorbs the energy of these effects and gets warm. At that it continues to generate current and feed the electrical device. At the same time the heating of the galvanic cells based on the solid-state ionic conductors leads to a significant increase in ionic conductivity in these conductors. Ionic conductivity in each solid-state galvanic cell based on the solid-state ionic conductors increases exponentially at temperature rise because it is generally determined by an exponential temperature dependence of ionic conductivity in solid-state ionic conductors (Arrhenius-Frenkel dependence). Rate of the current-producing reactions at the electrodes increases at temperature rise exponentially, too. As a result, this leads to a considerable increase in discharge and energy characteristics of the chemical current source and a high-efficient multifunctional use of the chemical current source, namely:

(a) The chemical current source feeds the electrical devices.

(b) The chemical current source, containing the solid-state galvanic cells based on the solid-state ionic conductors will efficiently protect the electrical device against fire and (or) radiations due to its thermal stability and fire/explosion safety.

(c) Absorbing the energy of the detrimental effects, the chemical current source is getting warm and its charge/discharge parameters are increasing. Consequently, the efficiency of use of the chemical current source for the feeding of the electrical devices or some their parts under the extreme conditions increases as well.

Similarly, the claimed apparatus of the chemical current source can protect environment against detrimental effects 10 if a source of these effects is the electrical device 8. (FIG. 1).

In order to efficiently use the chemical current source for the protection against the detrimental effects from the different directions the chemical current source can be made as a thermal protection and (or) a protective shield for each direction (FIG. 2), or it can be made in the form of a cylinder with an inner hollow (FIG. 3). FIGS. 2-3 illustrate the chemical current source 1, the electrical device 8, and the directional negative effects 9.

The chemical current source, comprising the housing; one or several galvanic cells which are arranged within the housing, are connected between each other, contain the anode, the electrolyte and the cathode that are based on the solid-state ionic conductors; the current feedthroughs that serve as terminals for its connection with the electrical device has been tested. During the test the conditions of making of the chemical current source as a thermal protection and (or) a protective shield for the protection of the electrical device against intensive influence of fire and heat radiation, initiated by burning of diesel fuel were simulated. The chemical current source consisted of the metal housing and the galvanic cells, arranged within it and connected with each other in parallel or in series. The galvanic cells, according to the RF Patent No 2187178 HO1M 6/18, 10/36, Aug. 10, 2002, contained the solid-state ionic conductors with cubic structure of lead fluoride and tysonite structure of lanthanum fluoride.

According to the test results the high efficiency of making of the chemical current source as a protective unit for the protection of the electrical device or some its parts against influence of fire and heat radiation, initiated by burning of diesel fuel was proved. The current source was heated up to 6700 C and it operated stably under very severe conditions of direct action of intensive fire.

The present invention applies to the apparatus of the chemical current source, which allows realizing its multifunctional purpose, namely: the primary purpose is to serve as a current source and the extra purpose is to be a thermal protection and (or) a protective shield for complete or partial protection of the electrical device or some its parts against the external detrimental effects and (or) environment against similar negative effects if the electrical device or some its parts are a source of these effects.

What is claimed is:

1. A chemical current source comprising:
a housing; one or several galvanic cells which are arranged in the housing, are connected between each other, comprise an anode, an electrolyte and a cathode that are based on solid-state ionic conductors; current feedthroughs that serve as terminals for the connection with an electrical device, wherein the chemical current source is made as a thermal protection and/or a protective shield for the protection of the electrical device or some its parts against external influence of fire, and (or) radiation, and (or) mechanical effects, as well as for the protection of environment against similar effects going from the electrical device or some its parts.

2. The chemical current source according to claim 1, wherein it is made in the form of a plate.

3. The chemical current source according to claim 1, wherein it is made with an inner hollow.

4. The chemical current source according to claim 1, wherein it is made in the form of a hollow cylinder.

5. The chemical current source according to claim 1, wherein it serves as a case or a part of the case of the electrical device or some its parts.
